(19) United States
(12) Patent Application Publication
(10) Pub. No.: US 2004/0184604 A1
(43) Pub. Date: Sep. 23, 2004

(54) Secure method for performing a modular exponentiation operation

(76) Inventors: Marc Joye, Saint Zacharie (FR); Karine Villegas, Gemenos (FR)

Correspondence Address: BURNS DOANE SWECKER & MATHIS L L P, POST OFFICE BOX 1404, ALEXANDRIA, VA, 22313-1404, US

(21) Appl. No.: 10/486,340

(22) PCT Filed: Jul. 31, 2002
(86) PCT No.: PCT/FR02/02771

(30) Foreign Application Priority Data
Aug. 10, 2001 (FR) 01/10671

(51) Int. Cl. H04L 9/00

(52) U.S. Cl. 380/30

(57) ABSTRACT

The invention concerns a secure method for performing an exponentiation operation which consists in carrying out an operation of type U=V\hat{ }W modulo X. U, V, X are integers, W is an integer used in the form of a number W* masked by a fractional masking parameter randomly selected at each execution of the method. The invention is applicable to smart cards.

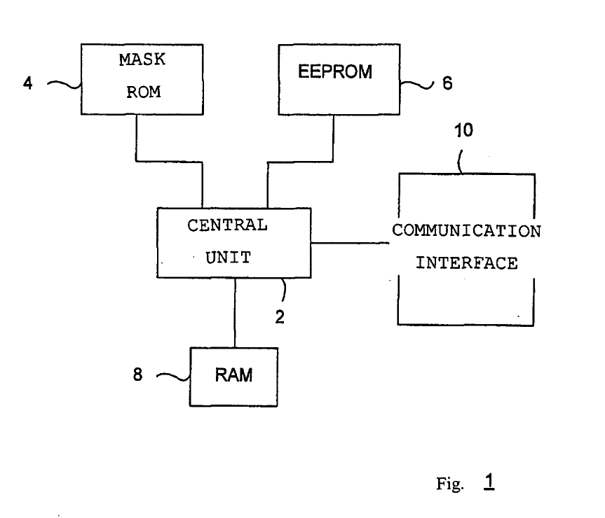

The present invention concerns a secure method for performing an exponentiation operation, with application in particular in the field of cryptography. The invention applies in particular to cryptographic algorithms implemented in electronic devices such as smart cards.

Many cryptographic algorithms are based on exponentiation calculations of the type U=V\hat{ }W modulo X, where U, V and X are integer numbers most often large in size, and W is a predetermined number. The numbers U, V can correspond for example to an encrypted text or one to be encrypted, a signed data item or one to be signed, a verified data item or one to be verified, etc. The numbers W and X can correspond to elements of keys, either private or public, used for encryption or decryption of the numbers U, V.

One of these algorithms is the RSA (Rivest, Shamir and Adleman) algorithm, which makes it possible to obtain a signature or a decrypted message s using a private key comprising three integer numbers d, p and q, p and q being large prime numbers, the product of which is equal to N. In a typical example, d and N have 1024 bits, and p and q have 512 bits.

Many works present the RSA algorithm in detail; it is however necessary to repeat here the basic principles of this algorithm, which makes it possible to calculate the signature s:

s=m\hat{ }d mod(p.q)=m\hat{ }d mod(N)

The RSA algorithm can be implemented using the Chinese Remainder Theorem. Through the application of this theorem, the signature s is obtained by:

s=m\hat{ }d mod(N)=CRT(sₚ, s_{q})

The function CRT(sₚ, s_{q}) is commonly referred to as the recombination formula according to the Chinese Remainder Theorem. The CRT function is calculated for example as follows:

CRT(sₚ, s_{q})=sₚ+p×Y,

with:

Y=iₚ(s_{q}−sₚ) mod(q)

dₚ=d mod(p−1), sₚ=m\hat{ }dₚ mod(p)

d_{q}=d mod(q−1), s_{q}=m\hat{ }d_{q} mod(q)

iₚ=(1/p) mod(q)

The same algorithm makes it possible to verify the validity of the signature s of a message m by verifying that the equation:

m=s\hat{ }e mod(N)

is satisfied.

The numbers e and N form the public key associated with the private key (d, p, q); the numbers e and N verify the equations:

N=p×q

pgcd(e, Φ(N))=1

e×d=1 mod(Φ(N)),

Φ(N) being Euler's totient function defined by Φ(N)=(p−1)(q−1).

It should be noted that all the elements d, p, q of a private key and all the elements e, N of an associated public key are odd. This is because, p and q being large prime numbers, they are necessarily odd. Φ(N)=(p−1)(q−1) is therefore even and N=p×q is odd. As e and Φ(N) are mutually prime, e is odd. As e×d=1 mod(Φ(N)), e×d is odd, and therefore d is also odd.

Other algorithms, cryptographic or not, also use exponentiation operations of the type U=V\hat{ }W modulo X, possibly implemented by the Chinese Remainder Theorem, for example the Rabin-Williams cryptosystem or else the Diffie-Hellman key exchange modulo a composite number.

A malicious user can possibly institute covert channel attacks, aiming to discover in particular confidential information (like for example the numbers d or p) contained and manipulated in processing performed by the calculation device executing an exponentiation operation. The best-known covert channel attacks are referred to as simple or differential. Simple or differential covert channel attack means an attack based on a physical quantity measurable from outside the device, and whose direct analysis (simple attack) or analysis according to a statistical method (differential attack) makes it possible to discover information contained and manipulated in processing carried out in the device. These attacks can thus make it possible to discover confidential information. These attacks have in particular been disclosed by Paul Kocher (Advances in Cryptology—CRYPTO'99, vol. 1666 of Lecture Notes in Computer Science, pp. 388-397. Springer-Verlag, 1999).

Amongst the physical quantities that can be exploited for these purposes, there can be cited the execution time, the current consumption, the electromagnetic field radiated by the part of the component used for executing the calculation, etc. These attacks are based on the fact that, during the execution of an algorithm, the manipulation of a bit, that is to say its processing by a particular instruction, leaves a particular print on the physical quantity under consideration, according to the value of this bit and/or according to the instruction.

The aforementioned exponentiation algorithms have had to include countermeasures for preventing such attacks from succeeding.

Paul Kocher proposed in particular, in the document WO 99/35782, a procedure which consists in particular of masking the derived variables dₚ, d_{q} of the number d by the addition of a random integer number. More precisely, the variables dₚ, d_{q} are not used directly in the algorithm, but are used in the form of masked numbers dᵢ*=dᵢ+rᵢ×(p−1), with i equal to p or q, and rᵢ (rₚ or rq) random integer numbers, modified at each implementation of the algorithm. In one example disclosed in the document WO 99/35782, this procedure is used within the context of an RSA algorithm implemented according to the Chinese Remainder Theorem. The algorithm then breaks down as follows:

First of all sₚ* and s_{q}* are calculated:

sₚ*=[m\hat{ }dₚ*] mod(p)=[m\hat{ }(dₚ+rₚ×(p−1))] mod(p)

s_{q}*=[m\hat{ }d_{q}*] mod(q)=[m\hat{ }(d_{q}+r_{q}×(p−1))] mod(q)

Next the number s is calculated by means of the recombination formula:

s=s*=CRT(sₚ*, s_{q}*)

The equality s=s* is deduced from the definition of dₚ, d_{q}, dₚ*, d_{q}* and Fermat's theorem, according to which A\hat{ }(B−1)=1 mod(B) when B is a prime integer number and A is relatively prime with B. In the present case, the following is deduced from Fermat's theorem:

$$\begin{matrix}m \hat{} {d}_{p}^{*} = m \hat{} ( {d}_{p} + {r}_{p} \times ( p - 1 ) ) \\ = m \hat{} {d}_{p} \times m \hat{} ( {r}_{p} \times ( p - 1 ) ) \\ = m \hat{} {d}_{p} \times 1 [ mod ( p ) ] .\end{matrix}$$

Since m\hat{ }dₚ*=[m\hat{ }dₚ] [mod(p)], this gives sₚ=sₚ*. A similar reasoning makes it possible to deduce s_{q}=s_{q}*. Finally, as sₚ=sₚ* and s_{q}=s_{q}*, s=s*.

The procedure disclosed in the document WO 99/35782 is in particular effective for countering differential covert channel attacks. It also complicates simple attacks.

However, this procedure is not effective against a particular attack detailed below (which, for the sake of simplification, will subsequently be referred to as a CRT attack) within the context of an example relating to the RSA algorithm. More generally, the CRT attack can be envisaged for any algorithm implemented by means of the Chinese Remainder Theorem.

In the example of an RSA algorithm implemented by means of the Chinese Remainder Theorem, the CRT attack makes it possible to obtain the number p of the private key. It has been seen previously that the recombination formula making it possible to calculate s is written:

s=CRT(sₚ, s_{q})=sₚ+p×Y,

with

Y=iₚ×(s_{q}−sₚ) mod(q)

If p, q have a bits (for example 512 bits), then iₚ, sₚ, s_{q} have a bits, and so has Y. The product p×Y and the number s therefore have 2a bits. As sₚ has a bits, it is deduced therefrom that the a most significant bits of s are equal to the a most significant bits of the product p×Y.

Furthermore, the Hamming weight H(Y) of the number Y can be obtained by a simple covert channel attack during the calculation of Y. It should be noted that the Hamming weight of the number Y is the number of bits at “1” in the number Y.

Knowing the most significant bits of the product p×Y and the Hamming weight of the number Y, it is possible to find the number p by successive iterations as follows:

an assumption is made on the value of b (for example b=8) most significant bits of p and the corresponding b most significant bits of Y are determined from the most significant bits of the product p×Y, which are given by the value of s. The probability that the assumption on the b most significant bits of p is correct is then calculated from the Hamming weight of Y, measured by a covert channel;

a reiteration is performed for each possible value of the b most significant bits of p and finally the most probable assumption for these b bits is adopted;

a reiteration is then performed for each packet of b bits of p, until a sufficient number of bits of p is obtained.

The procedure disclosed in the document WO 99/35782 is not effective against this CRT attack. This is because, in the document WO 99/35782, the recombination formula used is written:

s=CRT (sₚ*, s_{q}*)=sₚ*+p×Y*,

with s, p×Y* having a size of 2a bits and sₚ* having a size of a bits.

It is therefore possible, by means of a CRT attack as just described, to determine the number p from the known number s, the product p×Y* and the Hamming weight of (Y*).

In view of the limitations of the procedure disclosed in the document WO 99/35782, one object of the invention is to propose a secure method for performing an exponentiation operation, protected against all attacks, including the CRT attacks as described above.

Another object of the invention is to propose a secure method for performing an exponentiation operation, at least as efficient as the method disclosed in the document WO 99/35782, in particular in terms of circuit size and calculation time.

Finally, another object of the invention is to implement a secure method for calculating an exponentiation operation, capable of being incorporated into any calculation method during which a calculation of the type U=V\hat{ }W modulo X has to be performed.

With these objectives in view, the object of the invention is a secure method for performing an exponentiation operation during which an operation of the type U=V\hat{ }W modulo X is performed, U, V, X being integer numbers, W being an integer number used in the form of a number W* masked by a masking parameter chosen randomly at each execution of the method.

According to the invention, the masking parameter is a fractional number.

The numbers W, X are in practice numbers that must be kept concealed, like elements of a private key, and/or numbers derived from such a key. For example, if the method according to the invention is used within the context of an RSA algorithm implemented according to the Chinese Remainder Theorem, the number W can be the variables dₚ, d_{q} used in a customary manner. The size of the numbers W, X is immaterial; it is for example 1024 bits.

The use of a fractional random masking parameter, instead of an integer random masking parameter, makes it impossible to obtain information on the number W by means of a covert channel attack or a CRT attack, as will be seen more clearly below in some examples.

According to preferred embodiments, the masking parameter is of the form R/K. R is a random integer number modified at each execution of the method. The size of the number R determines the security of the algorithm with respect to the so-called differential attacks; R can be chosen for example with a size of 32 bits. K is an integer number that is a divisor of the number Φ(X), Φ being Euler's totient function. K can be chosen constant or else can be modified at each execution of the method. The size of K is immaterial; it is for example close to the size of the number R.

Advantageously, the masked number W* is of the form W*=\overline{W}+\overline{R}. \overline{W} is the default part of the result of the division of W by K, and \overline{R} is equal to the product of the masking parameter (R/K) and the number Φ(X).

The result U can then be expressed as a function of (U*)\hat{ }K modulo X, with U*=V\hat{ }W* modulo X.

More precisely, the result U is equal to U=(U*)\hat{ }K×V\hat{ }Z modulo X, with U*=V\hat{ }W* modulo X. Z is the remainder from the integer division of W by K.

The method of the invention, as described above, can be used advantageously in a global cryptographic method.

In an example that will be described more precisely, the cryptographic method is of RSA type, and is implemented according to the Chinese Remainder Theorem. In this case, the invention is used in particular for masking a possibly derived key (for example the derived keys dₚ, d_{q}) by a masking parameter chosen randomly at each execution of the method, the masking parameter being a fractional number.

Another object of the invention is an electronic component comprising a calculation circuit for implementing a method according to the invention, for example, but not necessarily, within the context of a cryptographic algorithm.

Finally, another object of the invention is a smart card comprising said electronic component.

The invention and the advantages ensuing therefrom will emerge more clearly from a reading of the following description of a particular embodiment of the invention, given purely for information only and with reference to the single accompanying figure. This is an electronic device making it possible to implement the invention.

The single figure depicts in block diagram form an electronic device 1 capable of performing exponentiation calculations. In the example, this device is a smart card intended to execute a cryptographic program. To that end, the device 1 combines, in a chip, programmed calculation means consisting of a central unit 2 connected functionally to a set of memories including:

a memory 4 accessible for reading only, in the example of the mask ROM (mask read-only memory) type;

an electrically reprogrammable memory 6, in the example of the EEPROM (electrically erasable programmable ROM) type; and

a working memory 8 accessible for reading and writing, in the example of the RAM (random access memory) type. This memory comprises in particular the registers used by the device 1.

The executable code corresponding to the exponentiation algorithm is contained in program memory. This code can in practice be contained in the memory 4, accessible for reading only, and/or in the memory 6, which is rewritable.

The central unit 2 is connected to a communication interface 10 which provides the exchange of signals with regard to the outside and the powering of the chip. This interface can comprise pads on the card for a so-called “contact-based” connection with a reader, and/or an antenna in the case of a so-called “contactless” card.

One of the functions of the device 1 is to encrypt or decrypt a confidential message m respectively transmitted to, or received from, the outside. This message can concern for example personal codes, medical information, accounting on banking or commercial transactions, authorisations for access to certain restricted services, etc. Another function is to calculate or verify a digital signature.

To that end, the central unit 2 executes a cryptographic algorithm, using an exponentiation calculation, on programming data which are stored in the mask ROM 4 and/or EEPROM 6 parts.

In the example described here, the exponentiation algorithm is of RSA type, implemented by the use of the Chinese Remainder Theorem. The algorithm is used for signing a message m using a private key comprising three integer numbers d, p and q. In the example, d has 1024 bits, and p and q have 512 bits.

In the example, an exponentiation calculation s=m\hat{ }d mod(p.q) is performed, where m is a predetermined message and d, p, q are integer numbers which are elements of the private key. The number s obtained constitutes a signature of the message m.

The numbers d, p, q (elements of the key) are stored in a portion of the rewritable memory 6, of EEPROM type in the example.

When the exponentiation calculation device 1 is called upon for the exponentiation calculation, the central unit first of all stores the number m, transmitted by the communication interface 10, in working memory 8, in a calculation register. The central unit will next read the keys d, p, q contained in rewritable memory 6, in order to store them temporarily, for the time of the exponentiation calculation, in a calculation register in the working memory 8. The central unit then initiates the exponentiation algorithm.

According to the invention, the derived keys dₚ, d_{q} of the key d are masked by a random fractional number as follows.

The central unit first of all chooses a number kₚ which is a divisor of p−1, and a number k_{q} which is a divisor of q−1, with p, q being elements of the key; kₚ, k_{q} are stored in another calculation register in the working memory 8. According to the embodiment chosen, kₚ can be modified at each implementation of the algorithm or else can be kept constant. The size of kₚ is immaterial, but necessarily less than the size of p−1.

The central unit also chooses two random numbers rₚ, r_{q} and stores them in two other calculation registers in the working memory. rₚ, r_{q} are preferably modified at each implementation of the algorithm. The size of the numbers rₚ, r_{q} is generally a compromise between, on the one hand, the size of the memory 8 in which they are stored and the calculation times (which increase with the size of the numbers rₚ, r_{q}) and, on the other hand, the security of the algorithm (which also increases with the size of the numbers rₚ, r_{q}).

The central unit next calculates the following variables dₚ*, aₚ, d_{q}*, a_{q}:

dₚ*=\overline{d}ₚ+\overline{r}ₚ, (Formula 1)

aₚ=dₚ mod kₚ (Formula 2)

with \overline{d}ₚ=└dₚ/kₚ┘ and \overline{r}ₚ=rₚ×(p−1)/kₚ

d_{q}*=\overline{d}_{q}+\overline{r}_{q}, (Formula 3)

a_{q}=d_{q} mod k_{q} (Formula 4)

with \overline{d}_{q}=└d_{q}/k_{q}┘ and \overline{r}_{q}=r_{q}×(q−1)/k_{q}

\overline{d}ₚ, aₚ are respectively the result and the remainder from the integer division of dₚ by kₚ.

\overline{d}_{q}, aq are respectively the result and the remainder from the integer division of d_{q} by k_{q}.

The central unit stores the variables dₚ*, aₚ, d_{q}*, a_{q} in registers in the working memory. Subsequently, the intermediate variables obtained throughout the calculation will also be stored in a portion of the working memory 8.

The central unit next calculates the variables:

sₚ*=m\hat{ }dₚ* mod p

s_{q}*=m\hat{ }d_{q}* mod q

and then the signature s using the variables sₚ*, aₚ, kₚ, s_{q}*, a_{q}, k_{q}. For this, the central unit uses the fact that:

sₚ=[(m\hat{ }dₚ*)\hat{ }kₚ×m\hat{ }aₚ] mod(p), (Formula 5)

s_{q}=[(m\hat{ }d_{q}*)\hat{ }k_{q}×m\hat{ }a_{q}] mod(q), (Formula 6)

s=CRT(sₚ, s_{q}) (Formula 7)

It should be noted that the above expressions of sₚ, s_{q} are deduced from the fact that \overline{d}ₚ, \overline{d}_{q} and aₚ, a_{q} are defined so that dₚ=\overline{d}ₚ×kₚ+aₚ and dₚ=\overline{d}ₚ×kₚ+aₚ, which makes it possible to write:

$$\begin{matrix}{s}_{p} = [ m \hat{} {d}_{p} ] mod ( p ) \\ = ( m \hat{} {\overline{d}}_{p} ) \hat{} {k}_{p} \times m \hat{} {a}_{p} mod ( p ) \\ = m \hat{} ( {\overline{d}}_{p} \times {k}_{p} ) \times m \hat{} {a}_{p} mod ( p ) \\ = m \hat{} ( {\overline{d}}_{p} \times {k}_{p} ) \times m \hat{} ( {r}_{p} \times ( p - 1 ) ) \times \\ m \hat{} {a}_{p} mod ( p ) \\ = m \hat{} [ ( {\overline{d}}_{p} + {\overline{r}}_{p} ) \times {k}_{p} ] \times m \hat{} {a}_{p} mod ( p ) \\ = ( m \hat{} {d}_{p}^{*} ) \hat{} {k}_{p} \times m \hat{} {a}_{p} mod ( p ) \\ = ( {s}_{p}^{*} ) \hat{} {k}_{p} \times m \hat{} {a}_{p} mod ( p ) .\end{matrix} \qquad ( Fermat ' s theorem )$$

The demonstration of the correctness of the expression for s_{q} is of course similar.

In a practical example implementation where kₚ=k_{q} and aₚ=a_{q}, the equalities 5 and 6 make it possible to simplify the equality 7 in the form:

$$\begin{matrix}s = CRT ( {s}_{p} , {s}_{q} ) = \{ [ CRT ( {s}_{p}^{*} , {s}_{q}^{*} ) ] \hat{} {k}_{p} \times m \hat{} {a}_{p} \} mod N \\ = \{ ( {s}_{p}^{*} + p \times {Y}^{*} ) \hat{} {k}_{p} \times m \hat{} {a}_{p} \} mod N \\ = \{ [ CRT ( {s}_{p}^{*} , {s}_{q}^{*} ) ] \hat{} {k}_{p} \times m \hat{} {a}_{p} \} mod N\end{matrix} \qquad ( Formula {7}^{′} )$$

In a numerical example, kₚ=k_{q}=2 is chosen. In this case, aₚ=a_{q}=1 since all the elements of a secret key and of an associated public key are odd (see above). This is because, d, p and q being odd numbers, the numbers dₚ=d mod(p−1) and d_{q}=q mod(q−1) are also odd. Consequently, aₚ, the remainder from the division of dₚ by kₚ=2, is necessarily equal to 1. For the same reasons, a_{q}, the remainder from the division of d_{q} by k_{q}=2, is of course equal to 1.

The equality 7 is insensitive to differential and simple covert channel attacks. This is because the random terms in the numbers sₚ*, s_{q}* mask the data dₚ, d_{q}, just as in the document WO 99/35782.

Furthermore, the equality 7 is insensitive to CRT attacks. This appears more clearly in the simplified formula 7′. The sum sₚ*+p×Y*, essential for successfully concluding a CRT attack, does not appear directly in the equation 7′; it appears only to the power kₚ. However, it is surmised to be impossible to extract from s a kₚ^{th} root without knowing the modulus N. It is therefore not possible to calculate sₚ*+p×Y*; it is therefore not possible to obtain the bits of p by means of a CRT attack.

An algorithm according to the invention is therefore well protected against all these attacks.

1. A secure method for performing an exponentiation operation during which an operation of the type U=V\hat{ }W modulo X is performed, U, V, X being integer numbers, W being an integer number used in the form of a number W* masked by a masking parameter chosen randomly at each execution of the method, characterised in that the masking parameter is a fractional number.

2. A method according to claim 1, characterised in that the masking parameter is of the form R/K, where R is a random integer number and where K is an integer number that is a divisor of the number Φ(X), Φ being Euler's totient function.

3. A method according to claim 2, characterised in that the number K and/or the number R are modified at each execution of the method.

4. A method according to claim 2 or claim 3, characterised in that the masked number W* is of the form W*=\overline{W}+\overline{R}, \overline{W} being the default part of the result of the division of W by K, and \overline{R} being equal to the product of the masking parameter R/K and the number Φ(X).

5. A method according to one of claims 2 to 4, characterised in that the result U is a function of (U*)\hat{ }K modulo X, with U*=V\hat{ }W* modulo X.

6. Use of a secure method according to one of claims 1 to 5 in a cryptographic method.

7. Use of a secure method according to one of claims 1 to 5 in a cryptographic method implemented according to the Chinese Remainder Theorem, for masking a possibly derived key by a masking parameter chosen randomly at each execution of the method, the masking parameter being a fractional number.

8. Use of a secure method according to claim 7, characterised in that the cryptographic method is an RSA type method.

9. An electronic component comprising a calculation circuit for implementing a method according to one of claims 1 to 5.

10. An electronic component comprising means for implementing a cryptographic method using a method according to one of claims 1 to 6.

11. A smart card comprising an electronic component according to claim 9 or claim 10.
